(19) United States
(12) Patent Application Publication
(10) Pub. No.: US 2009/0039725 A1
(43) Pub. Date: Feb. 12, 2009

(54) BRUSHLESS MOTOR AND SERVO UNIT UTILIZING THE SAME

(75) Inventors: Tadayuki KANATANI, Kyoto (JP); Kazuhiro ONO, Kyoto (JP); Teppei SAKAI, Kyoto (JP)

Correspondence Address: NIDEC CORPORATION;c/o KEATING & BENNETT, LLP, 1800 Alexander Bell Drive, SUITE 200, Reston, VA, 20191, US

(73) Assignee: Nidec Corporation, Minami-ku (JP)

(21) Appl. No.: 12/186,784

(22) Filed: Aug. 6, 2008

(30) Foreign Application Priority Data
Aug. 7, 2007 (JP) 2007-205422

(51) Int. Cl. H02K 3/18; H02K 7/116

(52) U.S. Cl. 310/195; 310/83

(57) ABSTRACT

A servo unit is arranged to operate an actuator, and a brushless motor is utilized in the servo unit. The brushless motor includes a rotational portion provided with a shaft and a rotor magnet rotating integrally with the shaft, a bearing portion rotatably supporting the shaft, a housing provided with a cylindrical portion retaining the bearing portion and a base portion bulging radially outwards from an axially lower portion of the cylindrical portion, a stator provided with a stator core having an inner peripheral surface to radially oppose an outer peripheral surface of the cylindrical portion of the housing and coils formed by conductive wires wound around the stator core, and a motor circuit board disposed on an axially upper side of the base portion. The base portion of the housing is arranged on an outer peripheral surface with a substantially arcuate concave portion which is concave in a radially inward direction. The substantially arcuate concave portion contains a pin holder which is made of an electrically insulating material to hold a plurality of metal pins. The respective pins are electrically connected to the motor circuit board.

### BACKGROUND OF THE INVENTION

1. Field of the Invention

The present invention relates to a servo unit used to operate an actuator, and a brushless motor provided in the servo unit.

2. Description of the Related Art

An actuator controlled remotely or automatically has been conventionally utilized to operate a joint of an artificial robot or the like. Combinations of a plurality of servo units in series can be used to realize various operations of the joint of the artificial robot. In many cases, each of the servo units of this type is mounted with a brush motor or a coreless motor as a drive source.

A brush motor or a coreless motor mounted in a servo unit is required to rotate at a high rotation speed of at least 20,000 rotations per minute in order to generate enough rotary torque for an output shaft of the servo unit. Thus, there arises a problem of a large amount of noise generated by the high speed rotation of the brush motor or the coreless motor. There is also a problem in that the brush motor or the coreless motor mounted in the servo unit can only generate a low rotary torque because the motor is an inner rotor type in which a rotational body rotates inside of a stationary member.

### SUMMARY OF THE INVENTION

In order to overcome the problems described above, preferred embodiments of the present invention provide a brushless motor. The brushless motor according to a preferred embodiment of the present invention includes a rotational portion provided with a shaft disposed coaxially with a central axis and a rotor magnet rotating integrally with the shaft, a bearing portion having a substantially cylindrical shape and rotatably supporting the shaft, a housing provided with a cylindrical portion retaining the bearing portion, and a base portion bulging radially outwards from an axially lower portion of the cylindrical portion. The brushless motor of a preferred embodiment of the present invention preferably also includes a stator provided with a stator core having an inner peripheral surface arranged to radially face an outer peripheral surface of the cylindrical portion of the housing, coils defined by conductive wires wound around the stator core, and a motor circuit board disposed on an axially upper side of the base portion. The base portion of the housing is arranged on an outer peripheral surface with an arcuate concave portion which is concave in a radially inward direction. The arcuate concave portion fixes therein a pin holder which is made of an electrically insulating material to hold a plurality of metal pins. The respective plurality of pins are electrically connected to the motor circuit board.

Another preferred embodiment of the present invention provides a servo unit including the brushless motor described above. The servo unit according to a preferred embodiment of the present invention preferably includes a deceleration mechanism having a gear wheel portion fixed to a distal end of the shaft of the brushless motor, a plurality of gear trains engaged with the gear wheel portion, and an output shaft engaged with the plurality of gear trains, a control circuit board disposed on an axially lower side of the brushless motor and electrically connected to the brushless motor to control rotation of the brushless motor, a position detection mechanism connected to the control circuit board to detect a rotational position of the output shaft, and a chassis accommodating the brushless motor, the deceleration mechanism, the control circuit board, and the position detection mechanism. The respective plurality of pins held in the pin holder in the brushless motor are electrically connected to the control circuit board.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a cross-sectional view of a brushless motor according to a preferred embodiment of the present invention.

FIG. 2A is a plan view of a housing in the brushless motor of FIG. 1.

FIG. 2B is a cross-sectional view of the housing cut along line X-X indicated in FIG. 2A.

FIG. 3 is a perspective view of a pin holder in the brushless motor of FIG. 1.

FIG. 4A is a plan view showing a state where the pin holder is fixed to the housing.

FIG. 4B is a cross-sectional view of FIG. 4A cut along line Y-Y.

FIG. 5 is a plan view showing a state where a motor circuit board is fixed to the housing of FIG. 4A.

FIG. 6 is a cross-sectional view of a servo unit mounted with the brushless motor of FIG. 1.

FIG. 7 is a table comparing characteristics among the brushless motor of FIG. 1, a conventional coreless motor, and a conventional brush motor.

FIG. 8 is a plan view of a housing and a motor circuit board of a brushless motor according to another preferred embodiment of the present invention.

### DETAILED DESCRIPTION OF PREFERRED EMBODIMENTS

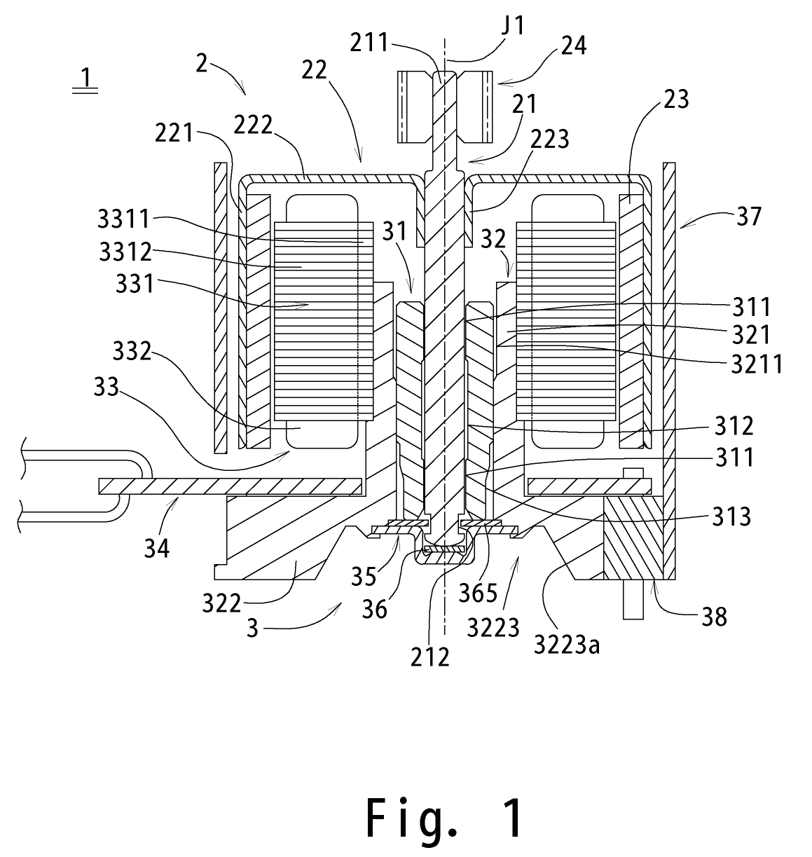

Referring to FIGS. 1 through 8, preferred embodiments of the present invention will be described in detail. It should be noted that in the explanation of the preferred embodiments of the present invention, when positional relationships among and orientations of the different components are described as being up/down or left/right, ultimately positional relationships and orientations that are in the drawings are indicated. Positional relationships among and orientations of the components once having been assembled into an actual device are not indicated. Additionally, in the following description, an axial direction indicates a direction substantially parallel to a rotation axis, and a radial direction indicates a direction substantially perpendicular to the rotation axis.

Description is given below to an entire configuration of a brushless motor according to a preferred embodiment of the present invention with reference to FIG. 1. FIG. 1 is a cross-sectional view, cut along an axial direction, of the brushless motor according to a preferred embodiment of the present invention.

A brushless motor 1 includes a rotational portion 2 rotating about a central axis J1, and a stationary portion 3 rotatably supporting the rotational portion 2.

The rotational portion 2 includes a shaft 21 having a rod shape disposed coaxially with the central axis J1, a rotor holder 22 fixed to the shaft 21 and provided with a cylindrical portion 221 which is disposed coaxially with the shaft 21 on the radially outer side, an annular rotor magnet 23 fixed to the inner peripheral surface of the cylindrical portion 221 of the rotor holder 22, and a gear wheel portion 24 fixed to the upper end of the shaft 21 to function as an output shaft.

There is provided on the shaft 21 on the axially upper side of the rotor holder 22, an upper radially reduced portion 211 having a diameter smaller than an outer diameter of a portion of the shaft 21 fixed with the rotor holder 22. The gear wheel portion 24 is fixed to the upper radially reduced portion 211.

The rotor holder 22 is made of a magnetic material, and includes a planar lid portion 222 extending radially inwards from the upper end of the cylindrical portion 221 and a cylindrical shaft fixing portion 223 extending axially downwards from the radially inner side of the lid portion 222 and having an inner peripheral surface fixed to the outer peripheral surface of the shaft 21.

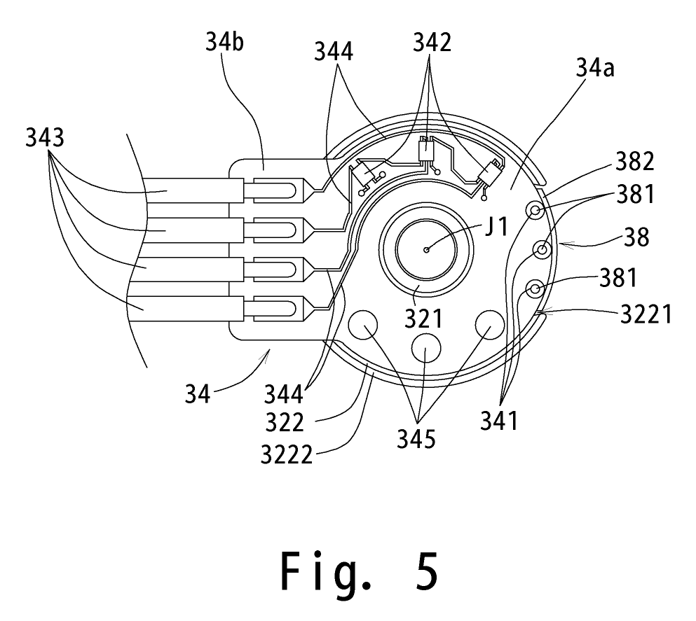

The stationary portion 3 includes a substantially cylindrical sleeve 31 disposed coaxially with the central axis J1 and provided with an inner peripheral surface arranged to radially and rotatably support the outer peripheral surface of the shaft 21, a housing 32 (made of, for example, aluminum) having a cylindrical portion 321 provided with an inner peripheral surface to retain the sleeve 31, a stator 33 having an inner peripheral surface fixed to the outer peripheral surface of the cylindrical portion 321, a motor circuit board 34 disposed axially below the stator 33 and attached to the housing 32, a plate 35 fixed to the axially lower end of the cylindrical portion 321 of the housing 32 to cover an opening of the cylindrical portion 321 on the lower side thereof, a thrust plate 36 disposed on the upper surface of the plate 35 to axially and rotatably support the shaft 21, and a cylindrical cover 37 fixed to the housing 32 and disposed on the radially outer side of the cylindrical portion 221 of the rotor holder 22 with a space provided therebetween. The sleeve 31 is preferably made of a sintered metal material which is impregnated with lubricant oil. The motor circuit board 34 includes an annular main body portion 34a and a square or substantially square external wiring portion 34b extending radially outwards from the main body portion 34a, as shown in FIG. 5.

The inner peripheral surface of the sleeve 31 includes two bearing surfaces 311 in contact with the outer peripheral surface of the shaft 21 and axially spaced apart from each other, and a radially increased surface 312 disposed axially between the bearing surfaces 311 to have a diameter larger than an inner diameter of the bearing surfaces 311. The sleeve 31 is also provided on the outer peripheral surface thereof with a radially reduced surface 313 having a reduced outer diameter below a position corresponding to the axially lower portion of the radially increased surface 312. The radially reduced surface 313 radially opposes the lower bearing surface 311.

The cylindrical portion 321 of the housing 32 is arranged at the upper portion of the inner peripheral surface with a radially increased portion 3211 having an inner diameter increased in comparison to the remaining portion. The radially increased portion 3211 radially opposes, with a small annular space provided there between, the outer peripheral surface of the sleeve 31 which radially opposes the upper bearing surface 311 on the sleeve 31. The sleeve 31 is fixed (through, for example press-fitting) to the cylindrical portion 321 of the housing 32 on the axially lower side of the radially increased portion 3211. The formation of the radially reduced surface 313 on the sleeve 31 causes the outer peripheral surface thereof radially facing the lower bearing surface 311 to radially face the inner peripheral surface of the cylindrical portion 321 with an annular space provided therebetween.

According to such a configuration, the outer periphery of the sleeve 31 at the portions radially facing the respective bearing surfaces 311 are not brought into radial contact with the inner peripheral surface of the cylindrical portion 321 when the cylindrical portion 321 and the sleeve 31 are fixed to each other. Thus, it is possible to prevent deformation of the bearing surfaces 311 due to press fitting, for example. Therefore, there is provided a brushless motor in which the center of the cylindrical portion 321 of the housing 32 is aligned with the center of the sleeve 31 and the respective bearing surfaces 311 have excellent accuracy. As a result, a reduction is achieved in the rotational variation of the shaft 21.

The upper end surface of the sleeve 31 is disposed axially below the upper end surface of the cylindrical portion 321. According to such a configuration, even in a case where the lubricant oil adhered onto the upper peripheral surface of the shaft 21 is spattered radially outwards by a centrifugal force of the shaft 21, the lubricant oil is adhered onto the inner peripheral surface of the cylindrical portion 321 which is then absorbed again by the sleeve 31. Accordingly, the sleeve 31 has a longer bearing life. In addition, even in a case where the rotating shaft 21 presses the upper bearing surface 311 indirectly via the lubricant oil and the lubricant oil is pressed out of the sleeve 31 onto the upper surface thereof, the lubricant oil thus pressed out is accommodated in the small annular space between the sleeve 31 and the inner peripheral surface of the radially increased portion 3211 of the cylindrical portion 321, and is then absorbed again by the sleeve 31. Accordingly, the sleeve 31 will have a longer bearing life.

An annular washer 365 is disposed axially between the lower end surface of the sleeve 31 and the upper surface of the plate 35. The shaft 21 has a lower radially reduced portion 212 arranged at a position radially facing the washer 365. The washer 365 has an inner diameter smaller than the outer diameter of the shaft 21 at the positions facing the respective bearing surfaces 311. Specifically, the inner peripheral surface of the washer 365 radially opposes the outer peripheral surface of the lower radially reduced portion 212 with a small space provided there between. The washer 365 functions to prevent the shaft 21 from being disengaged axially upwards from the sleeve 31.

The housing 32 is provided with a base portion 322 expanding radially outwards from the lower portion of the cylindrical portion 321. The base portion 322 has an annular and planar upper surface to which the motor circuit board 34 is fixed. The base portion 322 has a lower surface positioned axially below the lower surface of the plate 35, and the lower surface of the base portion 322 is provided at the center thereof with a circular concave portion 3223 around the central axis J1. The plate 35 is caulked (e.g., adhered) and fixed to the center of the circular concave portion 3223. The circular concave portion 3223 is provided on the periphery thereof with an annular inclined surface 3223a radially expanding toward the axially lower side. According to such a configuration, when the plate 35 is caulked to the base portion 322, it is easy to insert into the circular concave portion 3223 a caulking jig (not shown) provided with teeth, so that the plate 35 can be easily caulked and fixed to the base portion 322.

The cover 37 preferably has a cylindrical shape and a lower inner peripheral surface to be fixed to the outer peripheral surface of the base portion 322 by, for example, an adhesive agent. The cover 37 is provided at the lower portion thereof with a cutout portion corresponding to the external wiring portion 34b of the motor circuit board 34, so that the external wiring portion 34b of the motor circuit board 34 is led out of the cover 37 through the cutout portion.

The stator 33 includes a stator core 331 having an inner peripheral surface fixed to the outer peripheral surface of the cylindrical portion 321 of the housing 32, and coils 332 defined by a plurality of layers of conductive wires wound around the stator core 331. The stator core 331 has an annular core back portion 3311 (on the central axis J1 side with respect to the dashed lines of the stator core 331 in FIG. 1) having an inner peripheral surface fixed to the outer peripheral surface of the housing 32, and a plurality of teeth 3312 each extending radially outwards from the core back portion 3311. The respective teeth 3312 are arranged to be circumferentially spaced apart from one another (in the present preferred embodiment, twelve teeth 3312 are preferably provided, for example). The respective teeth 3312 have the conductive wires wound there around to define the coils 332 (in the present preferred embodiment, twelve coils 332 are provided). Each end of the coils 332 is electrically connected to the motor circuit board 34 by soldering or the like.

The housing 32 is preferably made of aluminum, so that heat generated at the stator 33 can be transferred through the housing 32. Thus, the heat generated at the stator 33 is released to the outside of the brushless motor 1.

An external power supply (not shown) directs current through the coils 332 of the stator 33, so that a magnetic field is generated in the periphery of the stator 33. The magnetic field and the rotor magnet 23 interact with each other to generate rotary torque about the central axis J1 for the rotational portion 2.

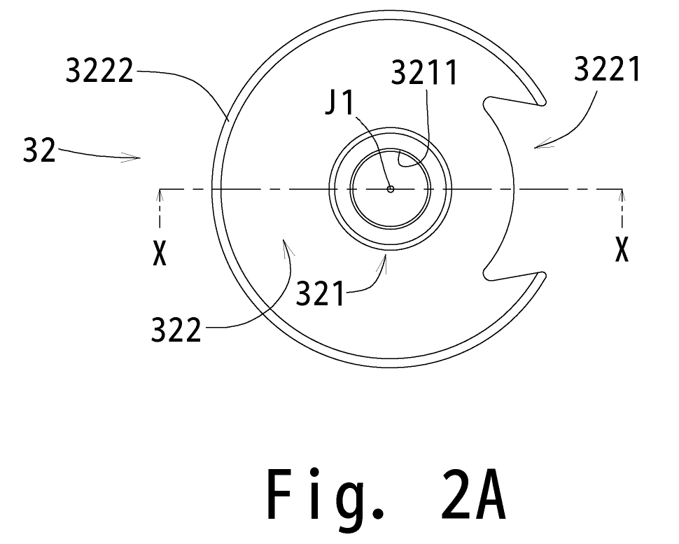

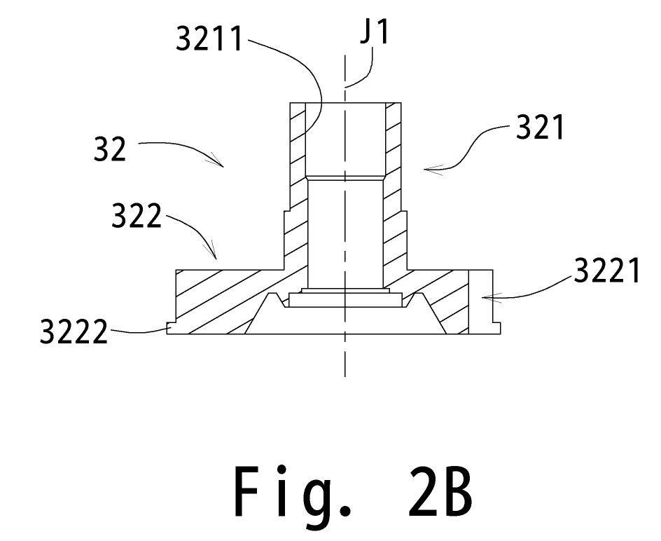

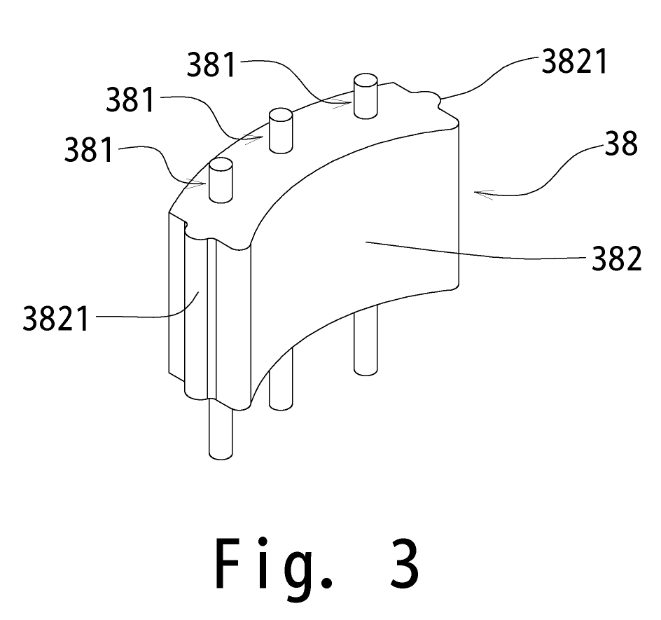

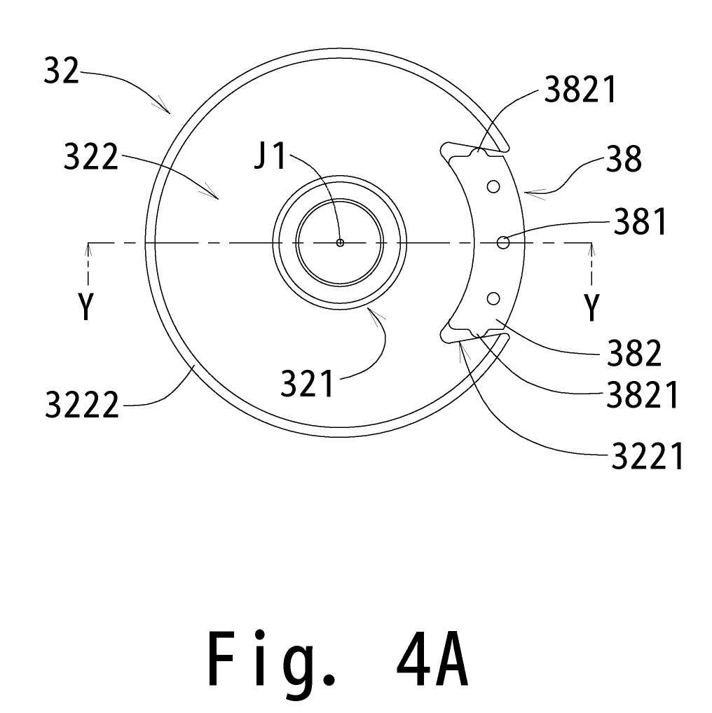

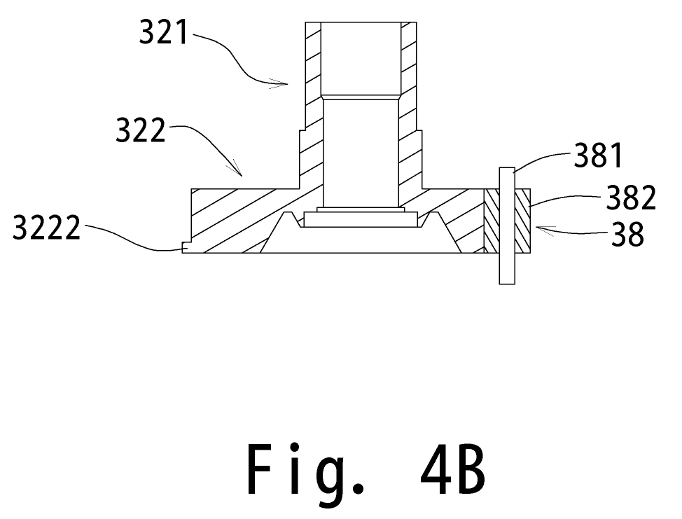

Details of the housing 32 and the motor circuit board 34 in the brushless motor 1 according to various preferred embodiments of the present invention are described below. FIG. 2A is a plan view of the housing 32 seen from above in the axial direction. FIG. 2B is a cross-sectional view of the housing 32 cut along line X-X indicated in FIG. 2A. FIG. 3 is a perspective view of a pin holder 38. FIGS. 4A and 4B are views showing a state where the pin holder 38 is fixed to the housing 32, while FIG. 4A is a plan view and FIG. 4B is a cross-sectional view cut along line Y-Y indicated in FIG. 4A. FIG. 5 is a plan view showing a state where the motor circuit board 34 is fixed to the housing 32 of FIG. 4A.

With reference to FIGS. 2A and 2B, there is provided an arcuate concave portion 3221, which is concave radially inwards, on a portion of the outer periphery of the base portion 322 of the housing 32. There are formed on the respective circumferential sides of the arcuate concave portion 3221, inclined surfaces such that the arcuate concave portion 3221 has a circumferential length reduced toward the radially outer side. The arcuate concave portion 3221 has a radially inner surface formed in a circular arc shape. The base portion 322 is provided with a projecting portion 3222, which projects radially outwards, on the entire lower outer periphery except the portion where the arcuate concave portion 3221 is provided. When the upper surface of the projecting portion 3222 is brought into contact with the lower surface of the cover 37, the axial position of the cover 37 is determined with respect to the housing 32.

With reference to FIG. 3, the pin holder 38 has a plurality of conductive pins 381 each in a shape of a stick, and a holder portion 382 made of an electrically insulating material (for example, a resin or plastic) to retain the respective pins 381 so as to be spaced apart from one another. In the present preferred embodiment, there are preferably provided three pins 381, for example, each penetrating the holder portion 382 such that the respective ends of each of the pins 381 project from the respective upper and lower surfaces of the holder portion 382.

The holder portion 382 is formed in a substantially circular arc shape in a plan view as seen from above in the axial direction. The holder portion 382 has circumferential side surfaces each provided with a raised portion 3821 projecting circumferentially outwards. Each of the raised portions 3821 is provided on the holder portion 382 along the axial direction and has a curved surface in a semicircular arc shape in a plan view.

With reference to FIGS. 4A and 4B, the pin holder 38 is fitted into the arcuate concave portion 3221 of the base portion 322 of the housing 32. The raised portions 3821 of the pin holder 38 are brought into contact with the circumferentially inner side surfaces of the arcuate concave portion 3221 in the housing 32, respectively, with an appropriate pressure therebetween. The pin holder 38 has an outer peripheral surface of which an outer diameter is substantially equal to that of the outer peripheral surface of the base portion 322 of the housing 32, more specifically, the outer diameter of the outer peripheral surface of the base portion 322 above the radially projecting portion 3222. In other words, the outer diameter of the outer peripheral surface of the pin holder 38 is smaller than the outer diameter of the outer peripheral surface of the radially projecting portion 3222 provided on the base portion 322.

Each of the circumferentially inner side surfaces of the arcuate concave portion 3221 and the corresponding circumferentially outer side surface of the pin holder 38 circumferentially face each other with a space which gradually increases toward the radially inner side. The pin holder 38 has a circumferential length between the two raised portions 3821 smaller than the circumferential length on the radially outermost side between the inner side surfaces of the arcuate concave portion 3221. Accordingly, the pin holder 38 is prevented from being disengaged radially outward from the arcuate concave portion 3221.

With reference to FIG. 5, the main body portion 34a of the motor circuit board 34 is disposed on the upper surface of the base portion 322 of the housing 32 as well as on the upper surface of the pin holder 38. The motor circuit board 34 is provided with three through holes 341 allowing the respective pins 381 in the pin holder 38 to be inserted there through. The pins 381 are inserted respectively into the through holes 341 and are soldered onto lands provided respectively in the periphery of the through holes 341 on the motor circuit board 34, so that the motor circuit board 34 and the pin holder 38 are electrically connected to each other.

The ends of the coils 332 of the stator 33 are soldered to be electrically connected to respective coil connection portions 345 formed on the upper surface of the motor circuit board 34. According to the present preferred embodiment, the stator 33 has three phases, so three coil connection portions 345 are included on the circuit board. As the coils 332 are connected with one another through a star connection, there is formed one neutral point, which is covered with an insulating member, such as a rubber tube.

Hall elements 342 (preferably three in the present preferred embodiment, for example) functioning as a position detection mechanism arranged to detect a position of magnetic poles of the rotor magnet 23 are disposed on the upper surface of the motor circuit board 34 at a position axially facing the rotor magnet 23. The respective hall elements 342 are wired to the wiring portion 34b of the motor circuit board 34 through a wiring pattern 344 on the motor circuit board 34. The wiring portion 34b is positioned to be circumferentially apart by about 180 degrees from the through holes 341, and the wiring portion 34b is connected by soldering to the connecting conductive wires 343 from a control circuit board (to be described later). Four respective connecting conductive wires 343 are connected to the upper surface and the lower surface of the motor circuit board 34. Signals output from the hall elements 342 are transmitted through the wiring pattern 344 and the connecting conductive wires 343 to the control circuit board.

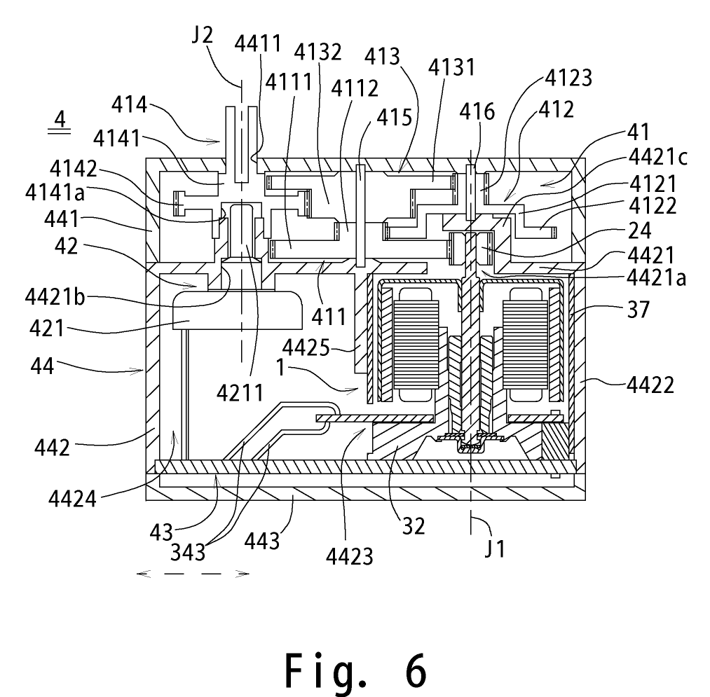

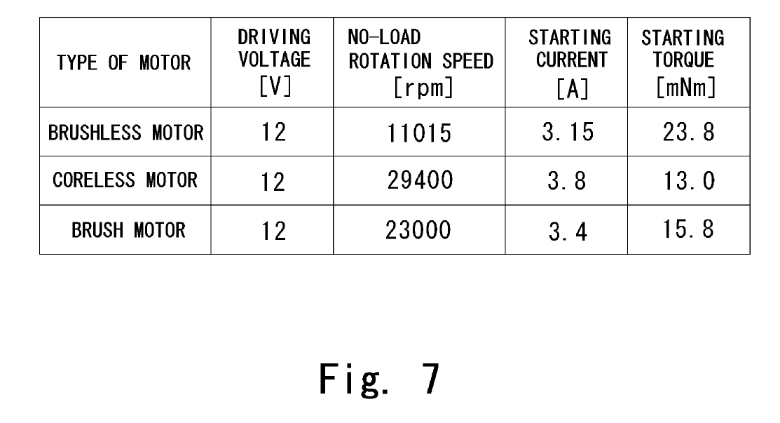

Description is given below to a servo unit 4 according to a preferred embodiment of the present invention with reference to FIGS. 6 and 7. FIG. 6 is a cross-sectional view of the servo unit 4 according to a preferred embodiment of the present invention. The servo unit 4 has an outline having a substantially flattened rectangular solid shape, of which the longitudinal direction is indicated by the dashed arrow in FIG. 6. FIG. 7 is a table comparing characteristics such as no-load rotation speed, starting current, and starting torque among the brushless motor 1 according to the various preferred embodiments of the present invention, a coreless motor, and a brush motor utilized in a conventional servo unit.

With reference to FIG. 6, the servo unit 4 includes the brushless motor 1, a deceleration mechanism 41 provided with an output shaft 414 arranged to output to the outside of the servo unit 4 rotary torque of the brushless motor 1, a position detection mechanism 42 arranged to detect an angle of rotation of the output shaft 414, a control circuit board 43 including a control circuit arranged to control rotation of the brushless motor 1, and a chassis 44 accommodating the brushless motor 1, the deceleration mechanism 41, and the position detection mechanism 42.

The chassis 44 preferably is formed in a substantially rectangular solid shape by, for example, injection molding a resin or plastic material. The chassis 44 has an upper chassis 441 to accommodate the deceleration mechanism 41, a lower chassis 442 disposed under the upper chassis 441 to accommodate the brushless motor 1, the position detection mechanism 42, and the control circuit board 43 and provided with an open lower side, and a lid body 443 to cover the open lower side of the lower chassis 442.

The lower chassis 442 has a top board portion 4421 and a side surface portion 4422 extending downwards from the outer peripheral edge of the top board portion 4421. The top board portion divides the inner space of the lower chassis 442 from the inner space of the upper chassis 441. The deceleration mechanism 41 is separated from the brushless motor 1, the position detection mechanism 42, and the control circuit board 43 by the top board portion 4421. The lower chassis 442 is provided with a first accommodating portion to accommodate the brushless motor 1, a second accommodating portion 4424 to accommodate the position detection mechanism 42, and a dividing portion 4425 to divide the first accommodating portion from the second accommodating portion 4424. The cover 37 of the brushless motor 1 is fixed to an inner surface of the first accommodating portion 4423 by, for example, an adhesive agent. The cover 37 is fixed to the first accommodating portion 4423 in a state where the upper end edge of the cover 37 is in contact with the lower surface of the top board portion 4421, so that the axial position of the brushless motor 1 is determined with respect to the chassis 44.

The top board portion 4421 in the first accommodating portion 4423 is provided with a first through hole 4421a allowing the gear wheel portion 24 of the brushless motor 1 to be inserted therethrough. Further, the top board portion 4421 in the second accommodating portion 4424 is provided with a second through hole 4421b allowing a rotational axis 4211 of a variable resistor 421 in the position detection mechanism 42 to be inserted there through.

The deceleration mechanism 41 includes a first gear wheel 411 engaged with the gear wheel portion 24, a second gear wheel 412 engaged with the first gear wheel 411 and disposed coaxially with the shaft 21 of the brushless motor 1, a third gear wheel 413 engaged with the second gear wheel 412 and disposed coaxially with the first gear wheel 411, and the output shaft 414 engaged with the third gear wheel 413 to output to the outside. Highly viscous grease is applied to the respective engaging portions among the gear wheel portion 24, the first gear wheel 411, the second gear wheel 412, the third gear wheel 413, and the output shaft 414. The first gear wheel 411, the second gear wheel 412, and the third gear wheel 413 define a plurality of gear trains. It is noted that the configuration of the plurality of gear trains is not limited to the configuration according to the present preferred embodiment.

There is provided a first coaxial pin 415 to arrange the first gear wheel 411 and the third gear wheel 413 coaxially with each other such that ends of the first coaxial pin 415 are fixed respectively to the upper chassis 441 and the top board portion 4421 of the lower chassis 442. The first gear wheel 411 and the third gear wheel 413 are rotatably supported by the first coaxial pin 415. Further, there is provided integrally with the top board portion 4421, a lid portion 4421c to cover the axially upper side of the gear wheel portion 24. There is disposed a second coaxial pin 416 substantially coaxially with the shaft 21 such that the ends of the second coaxial pin 416 are fixed respectively to the upper chassis 441 and the lid portion 4421c. The second gear wheel 412 is rotatably supported by the second coaxial pin 416.

The first gear wheel 411 includes a larger diameter portion 4111 having a large outer diameter and engaged with the gear wheel portion 24, and a smaller diameter portion 4112 having an outer diameter smaller than that of the larger diameter portion 4111 and provided on the axially upper side of the larger diameter portion 4111. The second gear wheel 412 includes a cup portion 4121 having an annular lid portion extending radially outwards from the second coaxial pin 416 and a cylindrical portion extending axially downwards from the outer peripheral edge of the lid portion, an annular larger diameter portion 4122 extending radially outwards from the lower end of the cup portion 4121 to be engaged with the first gear wheel 411, and a smaller diameter portion 4123 having an outer diameter smaller than that of the larger diameter portion 4122 and arranged on the axially upper side of the cup portion 4121.

The third gear wheel 413 is disposed on the axially upper side of the first gear wheel 411 with respect to the first coaxial pin 415. The third gear wheel 413 includes a larger diameter portion 4131 engaged with the smaller diameter portion 4123 of the second gear wheel 412 and a smaller diameter portion 4132 provided on the axially lower side of the larger diameter portion 4131.

The output shaft 414 is disposed coaxially with an axis J2 which is positioned at a center of the second through hole 4421b provided in the top board portion 4421, and includes a proximal portion 4141 extending along the axis J2 and a larger diameter portion 4142 extending radially outwards from the proximal portion 4141 to engage with the smaller diameter portion 4132 of the third gear wheel 413. The proximal portion 4141 is formed at the lower portion thereof with a concave portion 4141a allowing the rotational axis 4211 of the variable resistor 421 to be inserted therein. The upper portion of the proximal portion 4141 is exposed upwards from the upper chassis 441 through a through hole 4411 which is provided in the upper chassis 441 around the axis J2.

The control circuit board 43 which controls rotation of the brushless motor 1 is arranged on the lower end surface of the housing 32 of the brushless motor 1. The control circuit board 43 is retained within the chassis 44 between the lower portion of the lower chassis 442 and the lid body 443. The control circuit board 43 has a substantially rectangular shape extending along a longitudinal direction which is substantially perpendicular to the axial direction of the chassis 44. The upper surface of the control circuit board 43 is in contact with the lower surface of the housing 32. The pins 381 projecting downwards from the pin holder 38 are inserted respectively into through holes provided in the control circuit board 43 and the lower ends of the pins 381 are soldered respectively onto lands formed on the lower surface of the control circuit board 43, so that the control circuit board 43 is electrically connected to the motor circuit board 34 in the brushless motor 1 through the pins 381.

The motor circuit board 34 in the brushless motor 1 and the control circuit board 43 are electrically connected to each other not only through the pin holder 38 but also by soldering onto the control circuit board 43 the connecting conductive wires 343 which are connected to the wiring portion 34b of the motor circuit board 34. The pin holder 38 is arranged about 180 degrees from the connecting conductive wires 343 along the longitudinal direction (the direction indicated by the dashed arrow in FIG. 6) of the servo unit 4, so that the servo unit 4 can be made thinner in the direction substantially perpendicular to the longitudinal direction thereof.

The position detection mechanism 42 detects an angle of rotation of the output shaft 414 through the variable resistor 421 which is connected to the control circuit board 43. The variable resistor 421 is provided with the rotational axis 4211 which is inserted into the concave portion 4141a in the proximal portion 4141 of the output shaft 414. The variable resistor 421 detects an angle of rotation of the output shaft 414 about the axis J2 by the rotational axis 4211 which is connected to the output shaft 414. The variable resistor 421 is electrically connected to the control circuit board 43 and is controlled by the control circuit configured by the control circuit board 43 such that the variable resistor 421 stops driving to rotate the brushless motor 1 when, for example, the variable resistor 421 detects a predetermined angle of rotation of the output shaft 414 and outputs a predetermined output value.

In the brushless motor 1 according to a preferred embodiment of the present invention, the rotor holder 22 is fixed to the shaft 21 on the axially lower side of the gear wheel portion 24 so as to cover the sleeve 31. According to such a configuration, grease applied to the deceleration mechanism 41 and the gear wheel portion 24 can be prevented from entering the radial space between the outer peripheral surface of the shaft 21 and the bearing surfaces 311 on the sleeve 31. In particular, since the viscosity of the grease is higher than that of the lubricant oil contained in the sleeve 31, the grease adhered to the bearing surface 311 on the sleeve 31 or the grease adhered to the outer peripheral surface of the shaft 21 at a position radially opposing the sleeve 31 raises the current necessary to rotate the rotational portion 2. However, in the brushless motor 1 according to the preferred embodiments of the present invention, the rotor holder 22 can prevent the grease from entering the sleeve 31 side (specifically, the axially lower side of the rotor holder 22), so that it is possible to prevent a rise in the current necessary to rotate the rotational portion 2.

With reference to FIG. 7, because the rotor magnet 23 is preferably disposed radially outside of the stator 33 in the brushless motor 1 according to the various preferred embodiments of present invention, rotary torque can be increased in the brushless motor 1 in comparison to a conventional coreless motor or a conventional brush motor. Moreover, the brushless motor 1 according to the various preferred embodiments of the present invention can drive a servo unit of a predetermined output with a predetermined driving voltage at approximately half of the no-load rotation speed of the coreless motor or the brush motor. Accordingly, it is possible to simplify the deceleration mechanism, resulting in a decrease in the amount of noise generated by the rotation of the brushless motor 1. The simplified deceleration mechanism can also reduce the amount of noise generated by engagement of the gear wheels in the deceleration mechanism. Therefore, it is possible to provide a servo unit which generates less noise.

In comparison to the coreless motor or the brush motor, the brushless motor 1 mounted in the servo unit 4 can generate a larger starting torque with a predetermined driving voltage and less starting current. The brushless motor 1 is suitable, because of the extended operating period of time, for a servo unit operated by an electric cell and utilized in a toy or the like.

Description has been provided for the brushless motor and the servo unit according to preferred embodiments of the present invention. However, the present invention is not limited to the above but various modifications can be made within the scope of the appended claims.

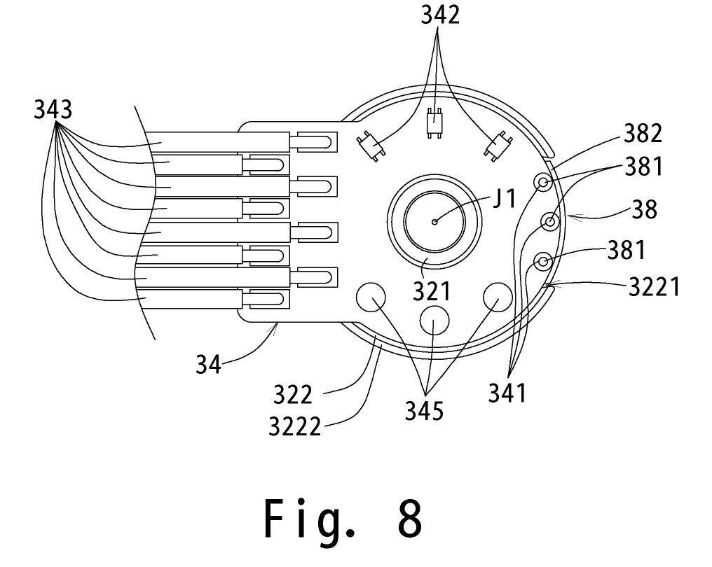

For example, while the connecting conductive wires 343 are connected to the upper surface and the lower surface of the motor circuit board 34 in the brushless motor 1 according to a preferred embodiment of the present invention, the present invention is not limited thereto. Alternatively, the connecting conductive wires 343 may be connected only to the upper surface or the lower surface of the motor circuit board 34. In a case where the connecting conductive wires 343 are connected only to one of the surfaces of the motor circuit board 34, the connecting conductive wires 343 are desirably connected to positions radially different from one another as shown in FIG. 8. FIG. 8 is a pattern plan view, seen from axially above, of the state of FIG. 5 with a modification made to a portion in the vicinity of the connecting conductive wires on the motor circuit board. It is noted that the wiring pattern is not illustrated in FIG. 8.

According to such a configuration, the adjacent connecting conductive wires 343 can be widely spaced apart from one another, so that the respective connecting conductive wires 343 may be easily connected. Moreover, as the respective connecting conductive wires 343 can be reliably connected, disconnection between each of the connecting conductive wires 343 and the motor circuit board 34 can be prevented even where an external impact is applied to the servo unit 4. Such a characteristic is specifically preferable to the servo unit 4 which is utilized in a joint of a toy robot which is susceptible to external impacts.

In addition, the connecting conductive wires 343 may be replaced with a flexible circuit board or a flexible flat cable.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A brushless motor comprising:
a rotational portion including a shaft disposed coaxially with a predetermined central axis and a rotor magnet rotating integrally with the shaft;
a bearing portion having a substantially cylindrical shape and rotatably supporting the shaft;
a housing including a substantially cylindrical portion retaining the bearing portion and a base portion extending radially outwards from an axially lower portion of the substantially cylindrical portion;
a stator including a stator core having an inner peripheral surface radially opposing an outer peripheral surface of the substantially cylindrical portion of the housing and a coil having a conductive wire wound around the stator core; and
a motor circuit board disposed on an axially upper side of the base portion; wherein
the base portion of the housing includes, on an outer peripheral surface thereof, a substantially arcuate concave portion which is concave in a radially inward direction;
the substantially arcuate concave portion contains a pin holder made of an electrically insulating material and arranged to hold a plurality of metal pins; and
the plurality of pins are electrically connected to the motor circuit board.

2. The brushless motor according to claim 1, wherein the pin holder has circumferential end surfaces in contact with circumferential side surfaces of the substantially arcuate concave portion, the substantially arcuate concave portion has a circumferential length between the respective side surfaces that is reduced toward a radially outside position, and a minimum distance of the circumferential length is smaller than a circumferential length of the pin holder between the circumferential end surfaces.

3. The brushless motor according to claim 2, wherein the pin holder is provided with a plurality raised portions raised from each of the circumferential end surfaces, and a circumferential end surface of each of the raised portions is in contact with the corresponding circumferential side surface of the substantially arcuate concave portion.

4. The brushless motor according to claim 3, wherein the circumferential length on a radially outermost side between the respective side surfaces of the substantially arcuate concave portion in the base portion of the housing is smaller than a circumferential length between the two raised portions.

5. The brushless motor according to claim 3, wherein each of the raised portions has a curved outer surface which is in contact with the substantially arcuate concave portion.

6. A servo unit comprising:
the brushless motor of claim 1;
a deceleration mechanism including a gear wheel portion fixed to a distal end of the shaft, a plurality of gear trains engaged with the gear wheel portion, and an output shaft engaged with the plurality of gear trains;
a control circuit board disposed on an axially lower side of the brushless motor and electrically connected to the brushless motor to control rotation of the brushless motor;
a position detection mechanism connected to the control circuit board to detect a rotational position of the output shaft; and
a chassis accommodating the brushless motor, the deceleration mechanism, the control circuit board, and the position detection mechanism; wherein
the plurality of pins held in the pin holder of the brushless motor are electrically connected to the control circuit board.

7. The servo unit according to claim 6, wherein
the motor circuit board includes the position detection mechanism arranged to detect a rotational position of the rotational portion, and a connecting conductive wire arranged to transmit a signal output from the position detection mechanism to the control circuit board;
the connecting conductive wire is disposed at a position circumferentially displaced by about 180 degrees from positions where the plurality of pins are disposed; and
the connecting conductive wire and the plurality of pins are respectively disposed in a direction aligned with a radial longitudinal direction of the chassis.

8. The servo unit according to claim 6, wherein
the rotational portion is disposed on a radially outer side with a cover having a substantially cylindrical shape;
the cover has an inner peripheral surface fixed to an outer peripheral surface of the base portion of the housing;
the chassis has a dividing plate integral with a side surface of the chassis such that the dividing plate has an outer diameter substantially equal to that of the cover; and
the cover has an outer peripheral surface fixed to the side surface of the chassis and a surface of the dividing plate radially facing the cover.

9. The servo unit according to claim 8, wherein
the base portion is provided on a lower portion with a radially projecting portion projecting radially outwards from the outer peripheral surface of the base portion, and an upper surface of the radially projecting portion is in contact with a lower end surface of the cover.

10. The servo unit according to claim 6, further comprising:
a rotor holder including a substantially cylindrical portion retaining the rotor magnet, a lid portion extending from the substantially cylindrical portion to the shaft, and a shaft fixing portion having an inner peripheral surface to be fixed to the shaft; wherein
the rotor holder is disposed axially below the gear wheel portion; and
the bearing portion is disposed axially below the lid portion of the rotor holder.

11. A servo unit comprising:
a brushless motor including:
a rotational body having an annular rotor magnet which rotates about a predetermined central axis; and
a stationary body having a stator provided with an outer peripheral surface radially opposing an inner peripheral surface of the rotor magnet;
a deceleration mechanism including a gear wheel portion fixed to the brushless motor, a plurality of gear trains engaged with the gear wheel portion, and an output shaft engaged with the plurality of gear trains;
a control circuit board disposed on an axially lower side of the brushless motor and electrically connected to the brushless motor to control rotation of the brushless motor; and
a chassis having a substantially rectangular solid shape to accommodate the brushless motor, the deceleration mechanism, and the control circuit board.

12. The servo unit according to claim 11, wherein the brushless motor is a three phase brushless motor.

13. The servo unit according to claim 11, wherein the rotational body is provided on a radially outer side with a cover having a substantially cylindrical shape attached to the stationary body; and when the cover is attached to the chassis, the brushless motor is fixed to the chassis.

14. A servo unit comprising:
a brushless motor including:
a rotational body having an annular rotor magnet which rotates about a predetermined central axis; and
a stationary body having a stator provided with an outer peripheral surface radially opposing an inner peripheral surface of the rotor magnet and a circuit board electrically connected to the stator to control rotation of the brushless motor;
a deceleration mechanism including a gear wheel portion fixed to the brushless motor, a plurality of gear trains engaged with the gear wheel portion, and an output shaft engaged with the plurality of gear trains; and
a chassis having a substantially rectangular solid shape to accommodate the brushless motor and the deceleration mechanism.
